(19) United States
(12) Patent Application Publication
(10) Pub. No.: US 2008/0023033 A1
(43) Pub. Date: Jan. 31, 2008

(54) Device for collecting debris from a well

(75) Inventor: Ronald Potter, Aboyne (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Rotary Drilling Supplies Europe Limited

(21) Appl. No.: 11/879,906

(22) Filed: Jul. 19, 2007

(30) Foreign Application Priority Data
Jul. 28, 2006 (GB) 0614990.0

(51) Int. Cl. B08B 15/00; B08B 9/027

(52) U.S. Cl. 134/10; 134/166 C; 134/22.11

(57) ABSTRACT

A device for collecting debris from a well comprises a fluid injection conduit injecting circulating fluid into the area of the well to be treated, a fluid collection pathway for the recovery of fluid and suspended debris, and a collection chamber for the collection of debris suspended in the fluid. The collection pathway is helical, and typically the collection chamber is also helical. Typically, the boundary between the collection pathway and the helical collection chamber is defined by vanes, typically including a groove capable of forming a watertight seal with a sleeve fitting substantially over the device. Devices may include a baffle located above the uppermost edge of the helical collection pathway to direct matter into the collection chamber. Methods to the use of the device to collect debris from the well can include multiple devices, each adapted to collect debris of different sizes.

### RELATED APPLICATION

This application is a U.S. National application claiming priority from British patent application GB 0614990.0.

### FIELD OF THE INVENTION

The present invention relates to a device for collecting debris in a well, particularly an oil or gas well, but embodiments of the invention also have utility in relation to water wells, and wells of other types.

### DESCRIPTION OF THE RELATED ART

The borehole of a typical well generally contains different amounts of unwanted debris, which in the production phase of the well can reduce the value of the produced fluids. There are several solutions for removing from the production fluids any solid particles of debris such as drill cuttings and scaly deposits that are removed from the casing during clean up operations, so that the produced fluids reaching the surface are less encumbered by unwanted material. This helps with the recovery process of the fluids themselves, and increases their commercial value. Typically, such devices are called junk catchers, and might be used in a cleaning string. Typically junk catchers will have an injection line for injecting clean circulating fluid into the well so that it mixes with the debris and washes it back up into the device through a recovery path in the tool for recovering the circulating fluid and separating any debris that is suspended in it. Typically, junk catchers have a junk collection chamber, in which the solid particles of debris that are separated from the circulating fluid are retained in the tool.

### BRIEF SUMMARY OF THE INVENTION

According to the present invention there is provided a device for collecting debris from a well comprising a fluid injection conduit for the injection of circulating fluid into an area of the well to be treated, a fluid collection pathway for the recovery of fluid and suspended debris, and a collection chamber for the collection of debris suspended in the fluid, wherein the collection pathway is helical.

In one embodiment of the invention, the collection chamber is also helical, and the collection pathway and collection chamber are typically formed as an auger with a two start helix within an annular portion of the apparatus, wherein the area circumscribed by the collection pathway is adapted to recover the mixture of returning circulation fluid and its suspended debris, for example by being open to the lower end of the well adjacent to the injection line, and wherein the area circumscribed by the collection chamber has one open end and one closed end. Typically, the collection chamber is open at its upper end and closed at its lower end, but the orientation of the device and the arrangement of its components can vary without departing from the scope of the invention. The open upper end of the collection chamber is typically in fluid communication with the collection pathway, and is typically provided with a baffle device or similar between the chamber and the pathway in order to divert the solid particles of debris from the collection pathway into the collection chamber.

The collection pathway typically has a filter device (typically set downstream of the baffle device) adapted to allow the passage of the circulation fluid, but adapted to retain solid particulate matter such as the debris suspended within the circulating fluid. The baffle device is typically adapted to preferentially divert the solid particulate matter retained by the filter device into the collection chamber.

Typically the collection chamber is helical in form, and at least two helical dividers, typically helical vanes, define the boundaries between the collection chamber and the collection pathway. Each helix typically has at least three complete helical turns, and typically more than three, for example five, seven, eight, nine, ten or more turns. This relatively long helix (particularly in annular form) provides a high capacity collection chamber for the debris, and a long collection pathway that is typically rotated with the string, and so is able to keep the suspended particles of debris in suspended form through the continuous agitation along the collection pathway. The helical pathway is typically right-handed and is typically rotated in use by being fixed to the rotary string, which is typically rotated in a clockwise direction. Thus, the rotation of the helical vanes of the collection pathway also help to move the suspended particles of debris up the collection pathway towards the inlet to the collection chamber. The helical pathway also applies centrifugal force to the mixture, which can assist in controlling the state of suspension of the particles, and also enhance their interaction with the baffles in order to divert the solid particulate matter into the collection chamber. After leaving the baffles and entering the mouth of the collection chamber, the screw effect generated by the helical arrangement of the walls in the collection chamber then typically forces the particulate matter down tightly into the collection chamber, thereby helping to compact the debris collected, and increases the effective capacity of the apparatus for collecting particulate matter in the well.

In a preferred embodiment, the injection conduit extends axially through the central axis of the helical pathway. This is an effective use of space in the device because the areas of the helical pathway and collection chamber that are closer to the central axis have a lower capacity and generates less centrifugal force than the more radially spaced areas. This efficient design enables shorter and narrower tools to be developed, while maximising the capacity. The double start helix can have the starts spaced at 180°, or at some other spacing in accordance with the required capacity of the collection pathway and the collection chamber. The collection chamber does not have to be the same size as the collection pathway. The pitch of the helix can be the same throughout the pathway, or it can vary in order to apply different forces to the fluid mixture in different parts of the pathway.

Preferably, the pitch of the helix may be increased to increase the amount of force exerted by the helix. The pitch of the helix may be increased by e.g. approximately 5°, 10°, 15°, 20°, 25°, 30°, 35°, 40°, 45°, or 50°. The device can be configured on a section of conventional drill pipe adapted to connect into a conventional cleaning string, and can comprise a pair of helical vanes welded to the outside of the drill pipe, and a sleeve covering the helical vanes. The device can have a front scooping portion adapted to divert fluids and suspended particulates below the device into the collection pathway.

The baffles can have a lower pitch of helix than the collection pathway and the collection chamber.

### BRIEF DESCRIPTION OF THE SEVERAL VIEWS OF THE DRAWINGS

An embodiment of the present invention will now be described by way of example, and with reference to the accompanying drawings, in which:

FIG. 1 is a side-sectional view of an embodiment of a debris-collecting device;

FIG. 2 is a side-sectional view of the FIG. 1 device rotated axially through 45°;

FIG. 3 is a sectional view through the lines AA of FIG. 1;

FIG. 4 is a sectional view through the lines BB of FIG. 1;

FIG. 5 is a side view of a seal portion of the FIG. 2 device;

FIG. 6 is a side-sectional view of a inner body of the FIG. 1 device;

FIG. 7 is a view similar to FIG. 6 but rotated axially through 45°;

FIG. 8 is a side view of a seal portion of FIG. 2;

FIG. 9 is a side-sectional view of the FIG. 8 seal;

FIG. 10 is a sectional view through lines AA of FIG. 7;

FIG. 11 is a plan view of a filter plate of the FIG. 1 device;

FIG. 12 is a sectional view through AA of the FIG. 11 filter plate;

FIG. 13 is a detail view of a portion of the FIG. 11 filter plate;

FIG. 14 is a detail view on arrow A of FIG. 11;

FIG. 15 is a view from beneath a scoop of FIG. 1;

FIG. 16 is a sectional view through the FIG. 15 scoop along the lines BB; and

FIG. 17 is a sectional view through the FIG. 15 scoop along the lines AA.

### DETAILED DESCRIPTION OF THE INVENTION

Referring now to the drawings, a debris collecting device 1 comprises an inner body 5 having box and pin connections at respective ends in order to facilitate connection of the inner body 5 into a conventional drill string or cleaning string. The inner body 5 has, on its outer surface, a pair of helical vanes 8a and 8b, which start at diagonally opposite positions on the inner body 5. The radially outermost edges of the helical vanes 8 are grooved to receive resilient seal 9 (e.g. a Viton® seal) (Viton is a register trademark of the DuPont Company.) The helical vanes 8 typically extend for at least two or three turns around the outer surface of the inner body 5, creating an auger having two separate helical pathways along the outer surface of the inner body 5. The lower ends of the helical vanes 8 (nearest to the pin end on the left hand side of the figures) are both at this stage open to the lower end of the inner body 5. The upper ends of the helical plates 8 are welded to upper helical baffles 12a and 12b respectively. The pitch of upper helical baffles 12 is less than the pitch of the helical vanes 8, and typically, the helical baffles 12 each extend only 180° around the circumference of the inner body 5. The upper baffles 12 terminate below a deflector plate 15 that is welded to the inner body 5, and has a generally inverted cup-shaped arrangement, so that the end of each upper plate 12 terminates within a cup formed by the deflector plate 15. The end termination of each upper plate 12 is spaced from the apex of the cup formed by the deflector plate 15, so there is a space between the end of the upper plate 12 and the deflector plate 15.

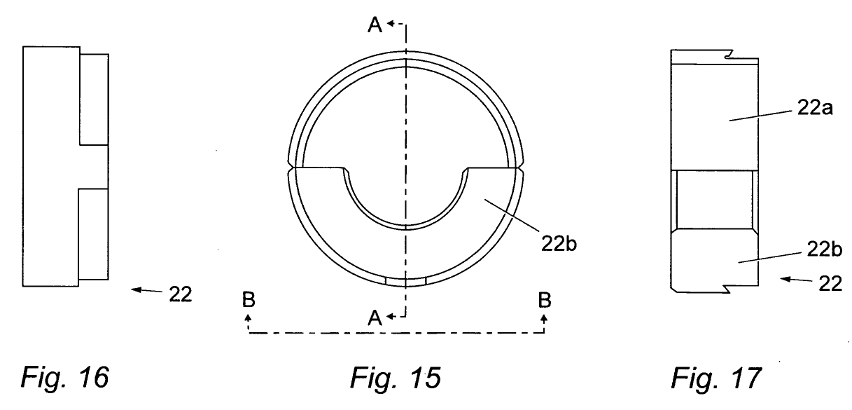

The helical vanes 8 and 12 and the deflector plate 15 are all encased within an outer sleeve 20 forming an outer housing. The sleeve 20 compresses the seal 9 to form a water-tight seal, thereby isolating the two helical channels 10a and 10b extending along the outer surface of the inner body 5. The lower end of the sleeve 20 has an end plug 22 shown in FIGS. 15 to 17. The lower end plug 22 is machined in one piece in an annular configuration and then split into two for assembly around the inner body 5 in use. The end plug 22 has a blanked portion 22b, which resists flow through one of the helical channels 10b, and an apertured portion 22a, which has an aperture to permit flow through the other of the helical channels 10a. The first helical channel 10a forms the collection pathway, and the second helical channel 10b forms the collection chamber. Beneath the end plug 22, an optional scoop device 25 can be fitted.

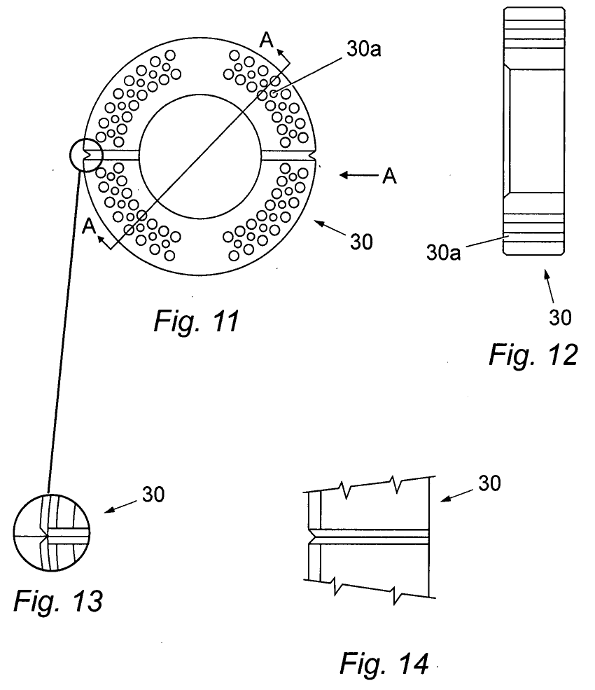

At the upper end of the annulus 20a, a filter ring 30 (shown in more detail in FIGS. 11 to 14) occludes the annulus between the sleeve 20 and the inner body 5. The filter ring 30 has a central bore to accommodate the inner body 5, and is manufactured as a single piece and then split to permit assembly in the same way as the end plug 22. The filter ring 30 has a series of apertures 30a in various patterns suitable for retaining the size of debris to be retained within the device. Above the filter ring 30, the outer sleeve 20 is bolted to fixing plates that are welded onto the inner body 5, in order to secure the whole assembly on the outer surface of the inner body 5 against rotation relative thereto.

In operation, the device 1 is typically rotated along with the inner body 5 as part of the string. Typically, this rotation can be initiated from the kelly on the rig, or by any other means desirable. The helical vanes 8 and baffles 12 are set in a clockwise helix when the string is to be rotated in a clockwise direction. If the string is to be rotated in an anticlockwise direction, the helical vanes 8 and baffles 12 can be set in the opposite configuration. The central bore 5b of the inner body 5 carries clean circulation fluid from the surface, and expels it from the string in a region of the well bore below the device 1 that is to be washed. The circulating fluid is expelled from the bore 5b and passes up the annulus between the string and the formation, washing suspended solids comprising junk to be recovered upwards in the annulus between the string and the formation (or the casing). When the debris-saturated circulation fluid reaches the lower end of the device 1, the optional scoop 25 diverts the fluid through the aperture 22a into the mouth of the open channel, and into the first helical pathway 10a (the collection pathway), which is axially aligned with the aperture 22a. The blanked portion 22b of the end plug 22 isolates the other helical channel 10b from the lower end of the device 1, and prevents the ingress of the fluid directly into the channel 10b from the lower end of the device 1. Optionally, the end plug 22 can be welded to the inner body 5 and the helical vanes 8 in order to effect the seal, and can optionally be sealed on its outer surface by means similar to the seal 9, so as to close off the collection chamber 10b entirely, thereby ensuring that the recovered circulation fluid that is saturated with debris only travels up the collection pathway 10a.

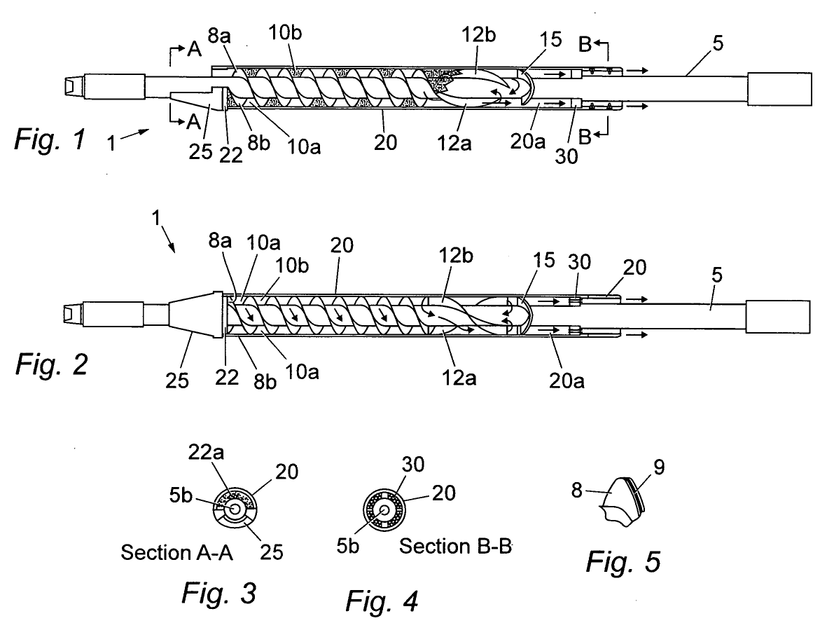

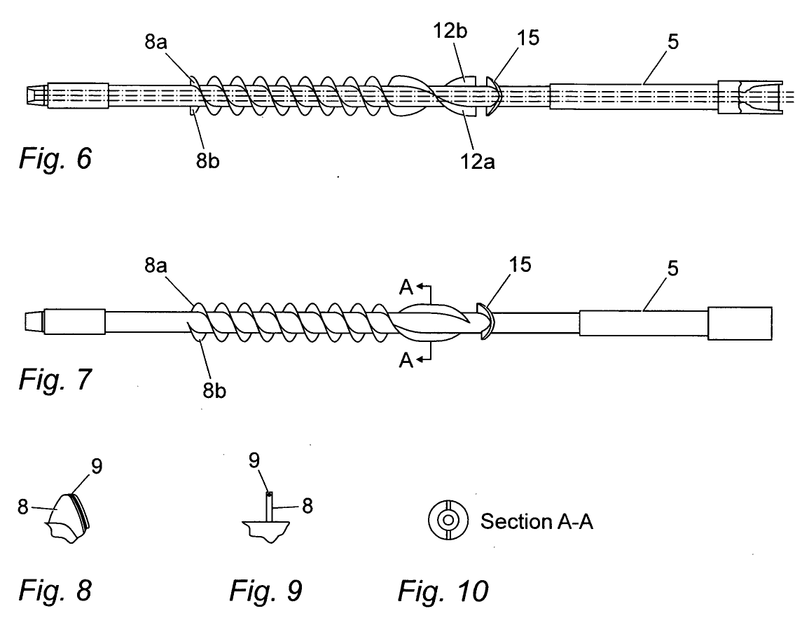

The clockwise rotation of the device 1 thereby moves the suspended debris and circulation fluid in the direction of the arrows shown in FIGS. 1 and 2 up the unshaded collection pathway 10a as shown in FIG. 1, until the circulation fluid and suspended debris reach the baffles 12 at the upper end of the collection pathway 10a. At this point, the debris continues to flow up the collection pathway 10a carried by the circulation fluid until it reaches the diverter plate 15, at which point the debris is mostly diverted downwards into the other helical pathway 10b (shaded in FIG. 1) which comprises the collection chamber, and which is spaced diametrically opposite to the collection pathway. The circulation fluid continues to move up the annulus 20a until it reaches the filter plate 30, at which point, any remaining particulate debris is retained below the filter plate 30, and clean circulating fluid is allowed to pass up through the top of the sleeve 20 as shown in FIGS. 1 and 2, and is recovered to surface. The particulate matter retained below the filter plate 30 falls down the annulus 20a and is diverted by the top surface of the diverter plate 15 into the helical collection chamber 10b.

The particulate debris from the baffles 12 and the diverter plate 15 continues to fall in a helical path down the helical collection chamber 10b and collects at the lower end adjacent to the end plug 22. Since the end plug 22 seals off the lower end of the collection chamber 10b in a blind ending, the particulate debris settles and is retained within the collection chamber. The clockwise rotation of the helical vanes 8 throughout serves to compress the particulate matter within the collection chamber 10b so as to drive it down to the lower end, and this helps to maximise the capacity of the device 1.

When the collection chamber 10b is full the string can be recovered to surface, and the end plug 22 removed (or the sleeve 20 removed by releasing the locking bolts) and the collection chamber emptied ready for a return trip. Similar devices 1 can be arranged in the same string in series, with finer filters to remove different sizes of particulate matter in the upper states of the well.

Modifications and improvements can be incorporated without departing from the scope of the invention. For example, magnets and other devices to retain junk within the collection chamber can be employed at the blanked portion 22b of the end plug 22 and can help to retain any metallic particles within the collection chamber 10b. The outer diameter of the sleeve 20 can be substantially the same as the drift size of the casing, so as to restrict the size of particulate matter that can pass outside the sleeve 20 without passing through the device, or the outer sleeve 20 can have a seal to close off the annulus and force debris into the collection pathway.

While the present invention has been described with respect to various preferred embodiments, it should be readily apparent to those skilled in the art that a variety of modifications are possible in light of the teachings provided herein.

1. A device for collecting debris from a well, the device comprising a fluid injection conduit for the injection of circulating fluid into an area of the well to be treated, a fluid collection pathway for the recovery of fluid and suspended debris, and a collection chamber for the collection of debris suspended in the fluid, wherein the collection pathway is helical.

2. A device as claimed in claim 1, wherein the collection chamber is helical.

3. A device as claimed in claim 2, wherein the device has an inner body, an outer sleeve extending around the inner body and an annulus between the outer sleeve and inner body, wherein at least two helical dividers are disposed within the annulus.

4. A device as claimed in claim 3, wherein the start positions of the helical dividers are rotationally spaced apart by 180 degrees.

5. A device as claimed in claim 1, wherein the helical collection pathway has at least three complete helical turns.

6. A device as claimed in claim 1, wherein the helical collection pathway is a right-handed helix.

7. A device as claimed in claim 1, wherein the helical pitch of the helical collection pathway is not constant.

8. A device as claimed in claim 1, wherein the collection chamber has at least two ends and is open to the collection pathway at one end.

9. A device as claimed in claim 8, wherein the open end of the collection chamber is the upper end when in use, the open upper end being in fluid communication with the collection pathway.

10. A device as claimed in claim 8, wherein the open upper end of the collection chamber includes at least one baffle.

11. A device as claimed in claim 10, wherein the at least one baffle is located between the collection pathway and the collection chamber, and wherein the baffle diverts solid debris particles from the collection pathway into the collection chamber.

12. A device as claimed in claim 10, wherein the at least one baffle is helical.

13. A device as claimed in claim 12, wherein the collection chamber is helical and the helical pitch of the at least one baffle is lower than the helical pitch of the collection chamber.

14. A device as claimed in claim 12 wherein the helical pitch of the at least one baffle is lower than the helical pitch of the collection pathway.

15. A device as claimed in claim 10, wherein the device has an outer circumference and the at least one baffle extends 180 degrees around the outer circumference of the device.

16. A device as claimed in claim 10, wherein the collection pathway includes a filter, the filter being adapted to facilitate fluid circulation and retention of solid particulate matter.

17. A device as claimed in claim 16, wherein the filter is located downstream of the at least one baffle and wherein the at least one baffle is adapted to divert solid particulate matter retained by the filter into the collection chamber.

18. A device as claimed in claim 10, wherein the device includes a deflector plate located above the at least one baffle.

19. A device as claimed in claim 18, wherein the at least one baffle has an uppermost edge and the deflector plate has the shape of an inverted cup having an apex, and wherein the uppermost edge of the at least one baffle is spaced away from the apex.

20. A device as claimed in claim 1 wherein the boundaries between the collection chamber and the collection pathway are defined by at least two helical vane.

21. A device as claimed in claim 20, wherein the vanes have a radially outermost surface that incorporates a groove.

22. A device as claimed in claim 21, wherein the groove receives a resilient seal.

23. A device as claimed in claim 21, wherein the device includes an outer sleeve fitting substantially over the length of the inner body of the device.

24. A device as claimed in claim 23, wherein the sleeve fits tightly over the vane grooves and resilient seal to form a watertight seal.

25. A device as claimed in claim 23, wherein the sleeve includes an end plug located at the lowermost end of the device, the end plug comprising a blanked portion resisting fluid flow out of the collection chamber and an aperture permitting fluid flow into the collection pathway.

26. A device as claimed in claim 1, wherein the fluid inlet conduit extends axially through the central axis of the collection pathway.

27. A device as claimed in claim 1, wherein the device includes a front scooping portion at the lower end of the device to direct matter within the well into the collection pathway.

28. A device as claimed in claim 1, wherein the fluid inlet conduit extends axially through the central axis of the collection pathway.

29. A device as claimed in claim 1, wherein the device includes means for connecting the device to a well string.

30. A device as claimed in claim 2, wherein rotational movement of the collection chamber compacts collected debris.

31. A device for collecting debris from a well, the device comprising a fluid injection conduit for the injection of circulating fluid into an area of the well to be treated, a fluid collection pathway for the recovery of fluid and suspended debris and a collection chamber for the collection of debris suspended in the fluid, defined in an annulus between an inner body and an outer sleeve extending around the inner body, wherein the collection pathway and the collection chamber are helical and at least two helical dividers are disposed within the annulus to separate the fluid collection pathway from the collection chamber.

32. A method of removing debris from a well using the device of claim 1, the method comprising the steps of:
a) connecting the device to a well string;
b) extending the well string and device into the well;
c) activating the device by injecting fluid through the device into the well.

33. A method as claimed in claim 32, method including the step of attaching multiple devices to a string, wherein each of the devices is adapted to filter different sized particulate matter.

34. A method as claimed in claim 32, wherein the device is rotated as part of the string.

35. A method of removing debris from an area of a well, the method comprising the steps of:
a) injecting circulating fluid into the area of the well to be treated to suspend the debris in the injected circulating fluid,
b) recovering the injected circulating fluid and suspended debris through a fluid collection pathway, and
c) collecting the suspended debris in a collection chamber, wherein
d) the fluid collection pathway is helical and the suspension of debris and fluid recovered through the collection pathway is guided along a helical path.
